(19) United States
(12) Patent Application Publication
(10) Pub. No.: US 2016/0125031 A1
(43) Pub. Date: May 5, 2016

(54) METHOD AND APPARATUS FOR RETRIEVING AND ORGANIZING PHYSICAL ADDRESSES

(71) Applicant: UMM AL-QURA UNIVERSITY, Makkah (SA)

(72) Inventors: Saleh BASALAMAH, Makkah (SA); Anas BASALAMAH, Makkah (SA)

(73) Assignee: UMM AL-QURA UNIVERSITY, Makkah (SA)

(21) Appl. No.: 14/399,287

(22) PCT Filed: Oct. 29, 2014
(86) PCT No.: PCT/IB14/02266

§ 371 Date: Nov. 6, 2014

(51) Int. Cl. G06F 17/30

(52) U.S. Cl. CPC G06F 17/30477; G06F 17/30345

(57) ABSTRACT

A method and apparatus for retrieving and organizing geographical address information. Each physical address is assigned a unique code including symbols and alphanumeric characters. This unique code is the electronic address assigned to each physical address. Certain of the electronic addresses and the corresponding physical addresses are assigned aliases. The electronic addresses are assigned on a semi-permanent basis (i.e., the electronic addresses are not changed unless there is change to the physical location); whereas the aliases can be freely changed and reassigned among the electronic addresses.

### BACKGROUND

Every location in the world has a physical address; different countries have different physical address formats. Physical addresses consist of several lines that describe the physical address (e.g., apartment/office number, building number, street, city, state and country).

An address is a collection of information, presented in a mostly fixed format, used for describing the location of a building, apartment, or other structure or a plot of land, generally using political boundaries and street names as references, along with other identifiers such as house or apartment numbers. Some addresses also contain special codes to aid routing of mail and packages, such as a ZIP code or post code.

Until the advent of modern postal systems, most houses and buildings were not numbered. Streets may have been named for landmarks, such as a city gate or market, or for the professions of their inhabitants. In many cities in Asia, most minor streets were never named. This is still the case today in much of Japan. When postal systems were introduced, it became necessary to number buildings to aid in mail delivery.

There was previously a topic of Physical Addresses of the ISO TC 154 (one of ISO technical committees). And there was, for many years, an international standard of Physical Addresses, the Article RL 123.3.3 of the Universal Postal Union Letter Post Regulations and most countries adopted those specifications. However, some countries kept their old address layouts and, a few years ago, the entire harmonization work collapsed, and the standard specifications were declared deprecated. So the harmonization process of addresses is actually going backwards. This is a huge problem not mainly for the postal services but for the computer industry producing administrative applications able to handle (how to store address data and print it right on envelopes) the different layouts. The topic is not known to be on the agenda of any of the postal or business administrative standard organizations today.

In most English-speaking countries, the standard is an alternating numbering scheme progressing in one direction along a street, with odd numbers on one side (usually west or south or the lefthand side leading away from a main road) and even numbers on the other (usually north or east or the righthand side leading away from a main road), although there is significant variation on this basic pattern. Many older towns and cities in the UK have “up and down” numbering where the numbers progress sequentially along one side of the road, and then sequentially back down the other side. Cities in North America, particularly those planned on a grid plan, often incorporate block numbers, quadrants, and cardinal directions into their street numbers, so that in many such cities, addresses roughly follow a Cartesian coordinate system. Some other cities around the world have their own schemes.

Although house numbering is the principal identification scheme in many parts of the world, it is also common for houses in the United Kingdom and Ireland to be identified by name, rather than number, especially in small towns. In these cases, the street name will usually follow the house name. Such an address might read: “Smith Cottage, Frog Lane, Barchester, Barsetshire, BA9 9BA” or “Dunroamin, Emo, Co. Laois, Ireland”.

In cities with Cartesian-coordinate-based addressing systems, the streets that form the north-south and east-west dividing lines constitute the x and y axes of a Cartesian coordinate plane and thus divide the city into quadrants. The quadrants are typically identified in the street names, although the manner of doing so varies from city to city. For example, in one city, all streets in the northeast quadrant may have “NE” prefixed or suffixed to their street names, while in another, the intersection of North Calvert Street and East 27th Street can be only in the northeast quadrant.

Street names may follow a variety of themes. In many North American cities, such as, San Francisco USA, and Edmonton, Canada, streets are simply numbered sequentially across the street grid. Washington, D.C. has its numbered streets running north-south and lettered or alphabetically named streets running east-west, while diagonal avenues are typically named after states. In Salt Lake City, and many other Utah cities, streets are in a large grid and are numbered in increments of 100 based on their location relative to the center of the city in blocks. A similar system is in use in Detroit with the Mile Road System.

Postal codes are a relatively recent development in addressing, designed to speed the sorting and processing of mail by assigning unique numeric or alphanumeric codes to each geographical locality.

In most of the world, addresses are written in order from most specific to general, e.g., finest to coarsest information, i.e. starting with the addressee and ending with the largest geographical unit. An example of a address format is shown in Table 1.

TABLE 1
Example of physical address format.

Name
Company name
Street
City area/District
City/Town/Village
County
Postal code
Country (in French/English)

### SUMMARY

According to aspects of this disclosure, an apparatus is provided having processing circuitry configured to associate a plurality of unique geographic addresses with a plurality of electronic addresses, each electronic address of the plurality of electronic addresses corresponding to a respective geographic address of the plurality of unique geographic addresses; associate at least one alias with at least one electronic address of the plurality of electronic addresses; receive a retrieval request including at least one of a requested alias and a requested electronic address; and retrieve at least one geographic address associated with the at least one of the requested alias and the requested electronic address.

According to one aspect of the present invention, the processing circuitry is further configured to receive a delete-alias request including instructions to sever an association of a first alias with a first electronic address; and sever the association of the first alias with the first electronic address, according to the instructions of the delete-alias request.

According to one aspect of the present invention, the processing circuitry is further configured to receive an add-alias request including instructions to associate the first alias with a second electronic address; and associate the first alias with the second electronic address, according to the instructions of the add-alias request, wherein the delete-alias request includes authentication data of a user, and the processing circuitry is further configured to sever the association of the first alias with the first electronic address, when the authentication data of the user indicates that the user is authorized to change the first alias, and the add-alias request includes authentication data of the user and the processing circuitry is further configured to associate the first alias with the second electronic address, when the authentication data of the user indicates that the user is authorized to change the first alias.

According to one aspect of the present invention, the processing circuitry is further configured to receive an address-retrieval request including authentication data of a user and address-retrieval instructions; authenticate, using authentication data of the user, whether the user is authorized to access the retrieved at least one geographic address; and provide to the user the retrieved at least one geographic address, when the user is authorized to access the retrieved at least one geographic address.

According to one aspect of the present invention, the processing circuitry is further configured to receive an add-geographic-address request including authentication data of a user and a to-be-added geographic address; authenticate, using authentication data of the user, whether the user is authorized to include the to-be-added geographic address in the plurality of unique geographic addresses; include the to-be-added geographic address in the plurality of unique geographic addresses and associate the to-be-added geographic address with a new electronic address, when the user is authorized to include the to-be-added geographic address in the plurality of unique geographic addresses. Moreover, the processing circuitry is further configured to receive a delete-geographic-address request including authentication data of a user and a to-be-deleted geographic address; authenticate, using authentication data of the user, whether the user is authorized to delete the to-be-deleted geographic address from the plurality of unique geographic addresses; delete the to-be-deleted geographic address from the plurality of unique geographic addresses and delete the electronic address associated with the to-be-deleted geographic address, when the user is authorized to delete the to-be-deleted geographic address from the plurality of unique geographic addresses.

According to aspects of this disclosure, a method is provided including the steps of: (1) associating a plurality of unique geographic addresses with a plurality of electronic addresses, each electronic address of the plurality of electronic addresses corresponding to a respective geographic address of the plurality of unique geographic addresses; (2) associating at least one alias with at least one electronic address of the plurality of electronic addresses; (3) receiving a retrieval request including at least one of a requested alias and a requested electronic address; and (4) retrieving at least one geographic address associated with the at least one of the requested alias and the requested electronic address.

According to aspects of this disclosure, a non-transitory computer readable storage medium including executable instruction is provided, wherein the instructions, when executed by circuitry, cause the circuitry to perform the steps of: (1) associating a plurality of unique geographic addresses with a plurality of electronic addresses, each electronic address of the plurality of electronic addresses corresponding to a respective geographic address of the plurality of unique geographic addresses; (2) associating at least one alias with at least one electronic address of the plurality of electronic addresses; (3) receiving a retrieval request including at least one of a requested alias and a requested electronic address; and (4) retrieving at least one geographic address associated with the at least one of the requested alias and the requested electronic address.

### BRIEF DESCRIPTION OF THE DRAWINGS

A more complete understanding of this disclosure is provided by reference to the following detailed description when considered in connection with the accompanying drawings, wherein:

FIG. 1 shows a figure describing the locations referenced by a series of physical addresses;

FIG. 2 shows a table of the physical addresses, which are shown in FIG. 1, with their corresponding aliases, electronic addresses, longitude, and latitude;

FIG. 3 shows an implementation of associating aliases with electronic addresses and associating electronic addresses with physical addresses;

FIG. 4 shows another implementation of associating aliases with electronic addresses and associating electronic addresses with physical addresses;

FIG. 5 shows an implementation of a method of retrieving address information; and

FIG. 6 shows an implementation of a database management system.

### DETAILED DESCRIPTION

Every location in the world has a physical address; different countries have different physical address formats. To overcome challenges with the lack of standardization of physical address formats, a second address—an electronic address—is assigned to each identifiable physical address. Herein the term “physical address” means a geographic address such as a street address or other known identifiers, including: a postal code, navigational coordinates, surveying nomenclature, and/or other geospatial taxonomic standards. Each electronic address assigned to a physical address is unique (i.e., no two physical addresses are assigned the same electronic address), and the electronic address is defined as a combination of alphanumeric characters and symbols (e.g., ASCII characters). In one implementation, the electronic addresses will have an intuitive meaning to human users of the electronic address, similar to the physical/postal address. In an alternative implementation, the electronic addresses will not have an intuitive meaning to human users (e.g., a binary code). In an another alternative implementation, the electronic addresses can have an intuitive meaning to users (e.g., physical coordinates such as a longitude, latitude, and elevation). The electronic address can provide a uniform standardized alternative to the non-standardized formats of postal and street addresses. A uniform standardization of the electronic addresses for each physical address on Earth can be adopted such that the electronic addresses are universally accepted and unique worldwide representing all addresses in the world.

Moreover, each electronic address can be provided to a database management system (DBMS), wherein each user of the DBMS is provided with user defined aliases for commonly used electronic and physical addresses—the aliases being shorthand codes that are readily recognized by the user. A given alias can be linked with a first electronic address and then later disassociated with the first electronic address and associated with a second electronic address, according to the dictates of the user. For example, if a resident A of the physical location corresponding to the first electronic address were to change their place of residence to the physical location corresponding to the second electronic address, then a user of the DBMS can change an alias titled “A's residence” from being associated with the first electronic address to being associated with the second electronic address.

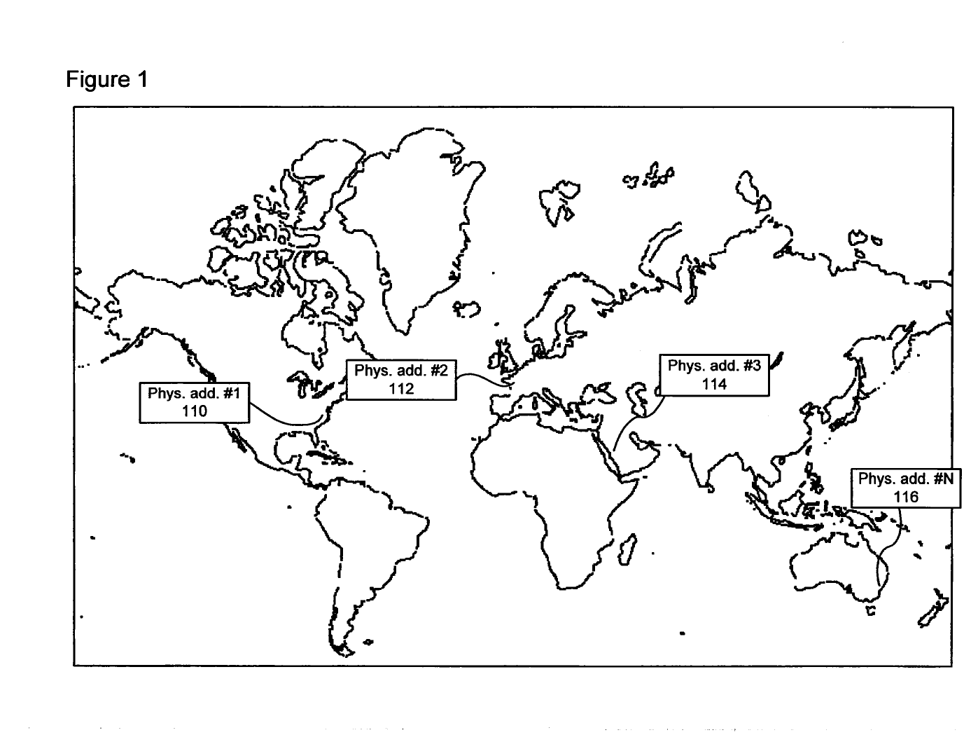

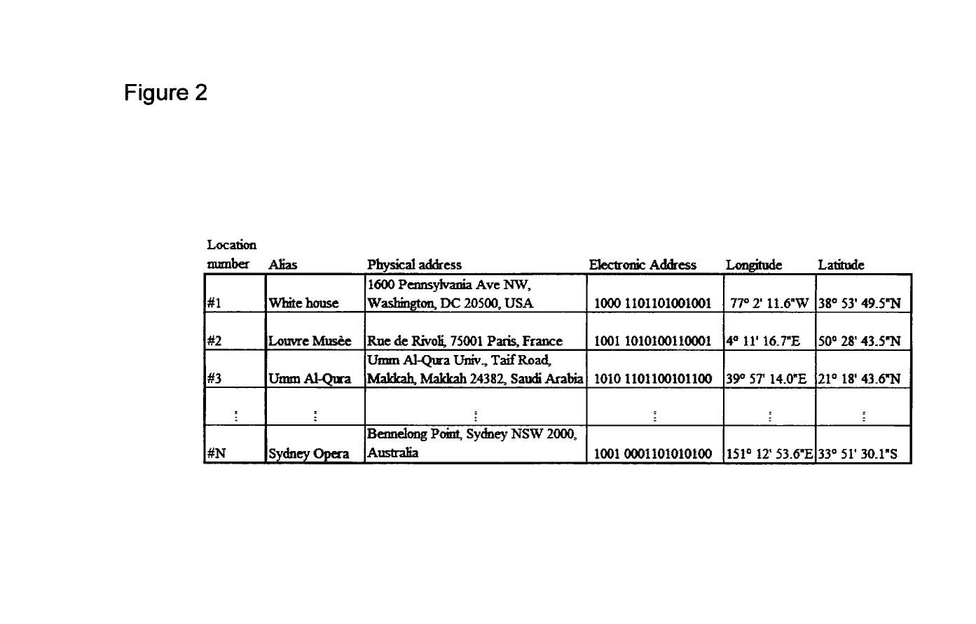

Referring now to the drawings, wherein like reference numerals designate identical or corresponding parts throughout the several views, FIG. 1 shows a map of Earth on which are indicated a series of physical locations, including: “Phys. Add #1” 110, “Phys. Add #2” 112, “Phys. Add #3” 114, and “Phys. Add #N” 116. FIG. 2 shows each location number along with a corresponding alias, physical address, electronic address, and longitude and latitude coordinates corresponding with the physical location. A unique electronic address is assigned to each uniquely identifiable residence, dwelling house, business structure, structure associated with a postal address, and recognized parcel of real property throughout the Earth. Each such identifiable location would be assigned a single unique electronic address.

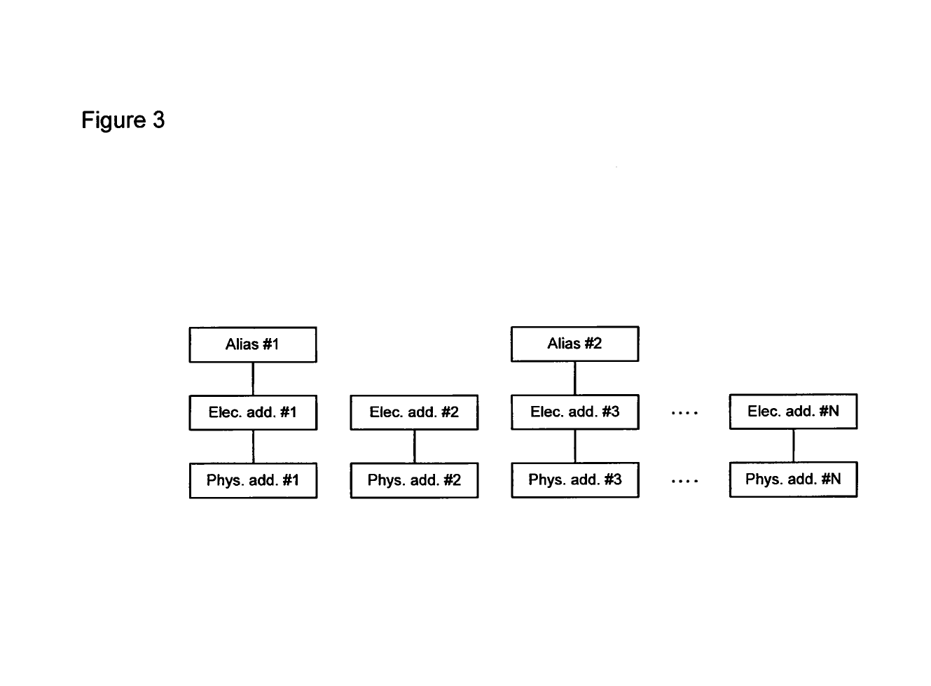

FIG. 3 shows a structure, wherein each electronic address is associated with a corresponding physical address, and some electronic addresses are associated with aliases. The aliases can each be user-defined phrases having intuitive meaning to the users of the DBMS. Whereas the electronic address is semi-permanently associated with a physical location (the association is only semi-permanent because, e.g., single family homes can be demolished and high rise apartments built in their places and real property can be subdivided into smaller parcels or combined into a larger parcel, necessitating changes in the electronic address assignments), the aliases assigned in a DBMS may be different for different users. One alias may be associated with one electronic address and then later be reassigned to be associated with a different electronic address. For example, a user can use the alias “My House” as the alias of the physical and electronic address of the residency of the user. When the user changes their residence, then the user can change the alias “My House” to point to the physical and electronic address of the new residency of the user.

The DBMS can include functionality to add and delete physical addresses from the DBMS. For example, physical addresses can be added when a parcel of land having a single physical address is subdivided into multiple parcels of land each having a unique physical address. Also, a physical address can be deleted when a physical address is no longer associated with a geographical location. For example, if global warming causes the polar ice caps to melt and sea level to rise enough that parts of Venice Italy are covered by the ocean, then the physical addresses associated with the now submerged parts of Venice Italy can be removed from the DBMS.

The functionality enabling the addition and deletion of physical addresses from the DBMS can be controlled using an authorization list, wherein only authorized users are enabled to add and delete physical addresses to and from the DBMS. Similarly, a second authorization list can be referenced for users that are authorized to access electronic and physical addresses from the list. When a user is authorized in accordance with this second authorization list, then the user will be able to retrieve electronic and physical addresses from the DMBS. If a user is not authorized in accordance with this second authorization list, then the user will not be able to retrieve electronic and physical addresses from the DMBS.

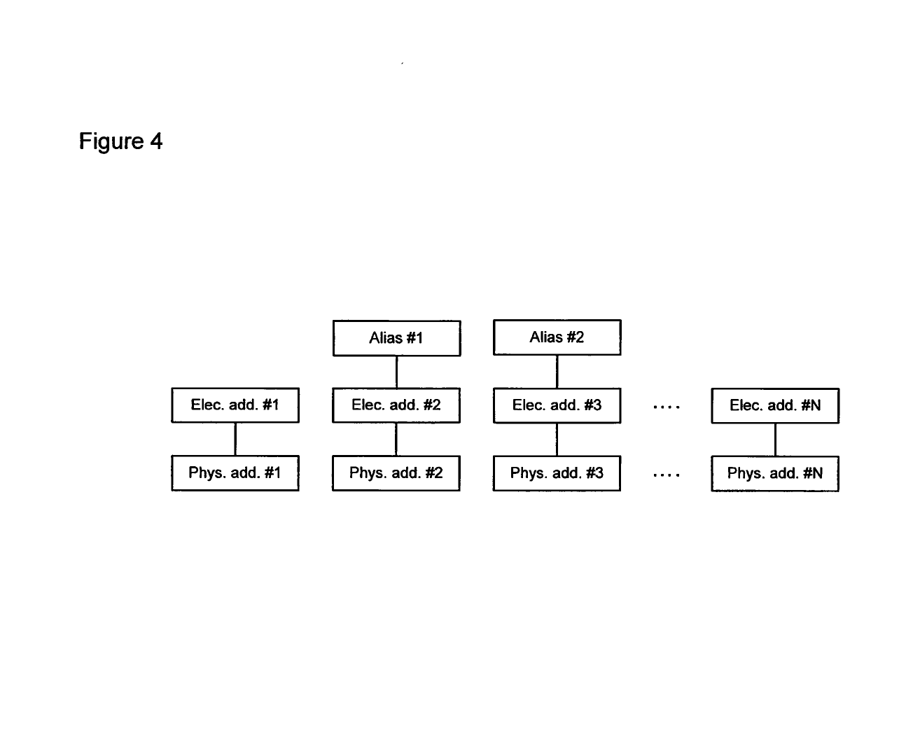

FIG. 3 shows “Alias #1” being associated with the electronic address “Elec. Add. #1,” and then in FIG. 4 the assignment of “Alias #1” is changed such that “Alias #1” is associated with the electronic address “Elec. Add. #2.” Whereas an electronic address is permanently assigned to the corresponding physical address, the aliases can be added, deleted, and reassigned among the electronic addresses according to the instructions received from a DBMS user. Thus, the aliases provide an intuitive and adaptable handle for users to identify and access electronic and physical addresses, whereas electronic and physical addresses can have a less intuitive nomenclature and taxonomy. The aliases can depend on which user is accessing the DBMS. For example, the alias by which a first user accesses a first electronic address and physical address may be different than the alias by which a second user accesses the first electronic address and physical address. Moreover, one user may associate more than one alias with a single electronic address and physical address.

For example, an alias may indicate the name of a resident living at a given physical address. Consider the case of the residency of the President of the United States. Thus, the physical address is “1600 Pennsylvania Ave. NW, Washington, D.C. 20500, USA,” corresponding to “Elec. Add. #1” in FIGS. 1 and 2. In addition to this physical address “Phys. Add. #1” 110 being associated with a first alias, e.g., the “White house” as shown in FIG. 2, the physical address “Phys. Add. #1” 110 can also have a second alias indicating the resident of physical address “Phys. Add. #1” 110. For example, the second alias, indicating the resident of physical address “Phys. Add. #1” 110, can be “Bill's house,” from Jan. 20, 1993 through Jan. 19, 2001, then between Jan. 20, 2001 and Jan. 19, 2009 the second alias of “Phys. Add. #1” 110 can be “George's house,” and then from Jan. 20, 2009 through Jan. 19, 2017 the second alias of “Phys. Add. #1” 110 can be “Barack's house.”

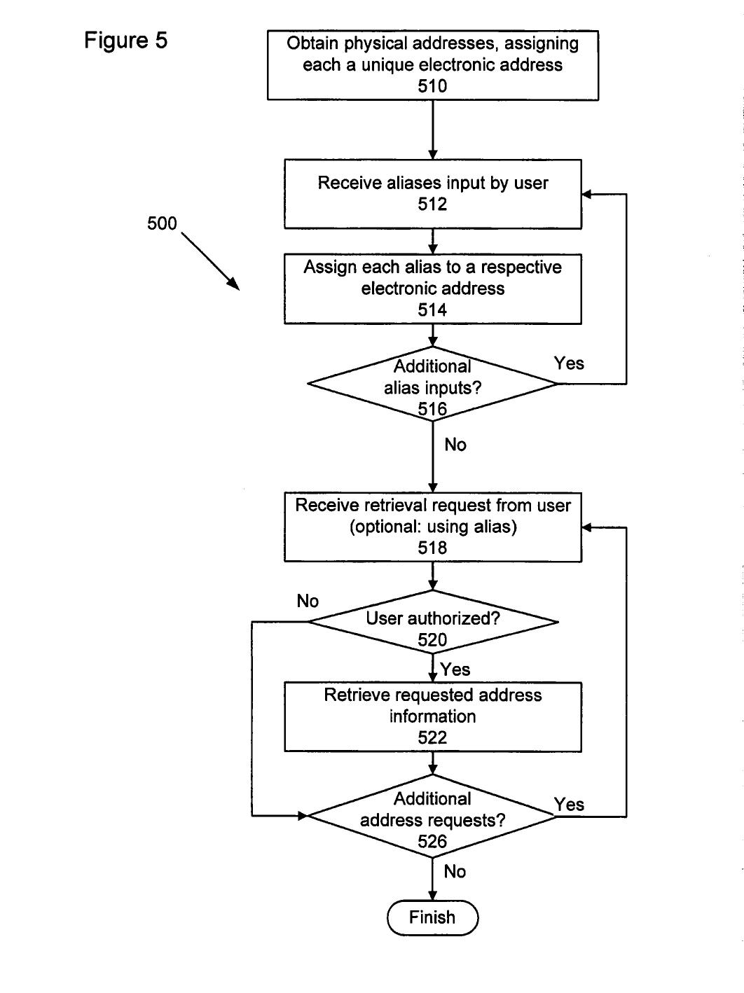

FIG. 5 shows a method 500 of retrieving electronic and physical addresses. The method 500 begins with step 510 by obtaining physical addresses and assigning each physical address a unique electronic address. In one implementation, step 510 is performed by reading the physical addresses and the corresponding unique electronic addresses assigned to the physical addresses from a computer readable medium, e.g., a CD, DVD, FLASH memory, RAM, ROM, PROM, EPROM, EEPROM, hard disk or any other information storing device. In one implementation, the physical and electronic addresses will have been previously stored on a computer readable memory, and step 510 will entail refreshing the computer readable memory and/or transferring the physical addresses from one computer readable memory to another computer readable memory (e.g., loading the address from non-volatile memory into volatile memory). Step 510 also includes each physical address corresponding to a distinct and identifiable physical location being associated with one unique electronic address.

Next, in step 512 of method 500, instructions are input by a user to assign aliases to the electronic and physical addresses.

Next, in step 514, the received aliases are assigned to certain of the electronic addresses according to the instructions input by the user. In addition to adding new aliases, step 514 also includes deleting and/or reassigning previously assigned aliases, according to the instructions input by the user. The deleted aliases are removed from the DBMS, and the reassigned alias will be associated with a new physical and electronic address rather than with the previously associated physical and electronic address.

Next, at step 516, method 500 inquires whether there are additional alias inputs. If there are additional alias inputs, method 500 returns to step 512. Otherwise, method 500 continues from inquiry 516 to step 518.

Next, in step 518 of method 500, a request is received to retrieve address information. The retrieval request can be initiated using an electronic address, an alias, and/or a physical address, and the retrieval request can return an electronic address, an alias, and/or a physical address.

Next, in step 520 of method 500, method 500 verifies the authorization of the user to access the address information. If the user is authorized to access the address information, then method 500 proceeds to step 522. Otherwise, method 500 skips step 522 and proceeds directly to step 526.

Next, in step 522 of method 500, the requested address information is retrieved and either made accessible to the user or is manipulated and recorded on a given computer readable medium according to the instructions received in the retrieval request.

Next, in step 526 of method 500, method 500 inquires whether there are additional retrieval requests. If there are additional retrieval requests, then method 500 returns to step 518. Otherwise, method 500 proceeds to a finished state.

The physical addresses, electronic addresses, and aliases can all be stored using a computer readable medium. In one implementation, the organization and storage of these values can be arranged using a linked-list architecture. In another implementation, the organization and storage of these values can be arranged using a table architecture. The DBMS will perform the functions of retrieving, sorting, storing, protecting, and updating address information.

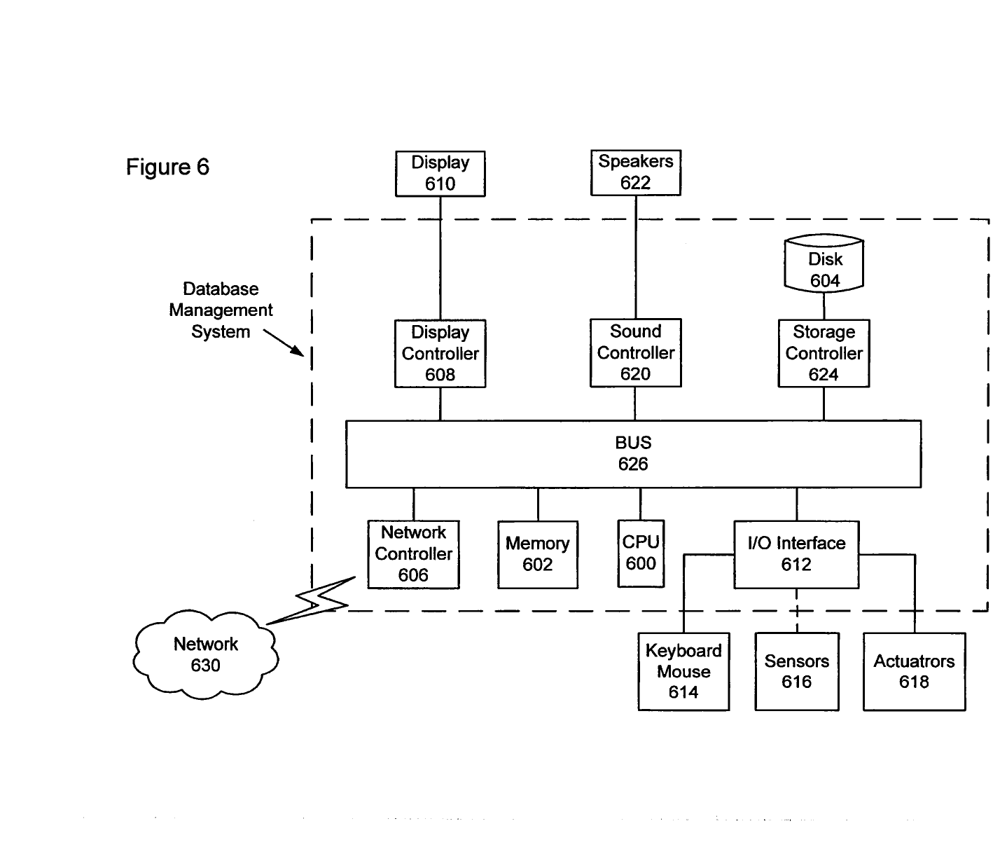

Next, a hardware description of the DBMS according to exemplary embodiments is described with reference to FIG. 6. In FIG. 6, the DBMS includes a CPU 600 which performs the processes described above. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the DBMS communicates, such as a server or computer.

Further, the claimed advancements may be provided as a utility application, background daemon, or component of an operating system, or combination thereof, executing in conjunction with CPU 600 and an operating system such as Microsoft Windows 7, UNIX, Solaris, LINUX, Apple MAC-OS and other systems known to those skilled in the art.

CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the inventive processes described above.

The DBMS in FIG. 6 also includes a network controller 606, such as an Intel Ethernet PRO network interface card from Intel Corporation of America, for interfacing with network 630. As can be appreciated, the network 630 can be a public network, such as the Internet, or a private network such as an LAN or WAN network, or any combination thereof and can also include PSTN or ISDN sub-networks. The network 630 can also be wired, such as an Ethernet network, or can be wireless such as a cellular network including EDGE, 3G and 4G wireless cellular systems. The wireless network can also be WiFi, Bluetooth, or any other wireless form of communication that is known.

The DBMS further includes a display controller 608, such as a NVIDIA GeForce GTX or Quadro graphics adaptor from NVIDIA Corporation of America for interfacing with display 610, such as a Hewlett Packard HPL2445w LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners, such as an OfficeJet or DeskJet from Hewlett Packard.

A sound controller 620 is also provided in the DBMS, such as Sound Blaster X-Fi Titanium from Creative, to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the DBMS. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

While certain implementations have been described, these implementations have been presented by way of example only, and are not intended to limit the teachings of this disclosure. Indeed, the novel methods, apparatuses and systems described herein may be embodied in a variety of other forms; furthermore, various omissions, substitutions and changes in the form of the methods, apparatuses and systems described herein may be made without departing from the spirit of this disclosure.

The above disclosure also encompasses the embodiments listed below.

(1) An address retrieval apparatus that includes processing circuitry configured to associate a plurality of unique geographic addresses with a plurality of electronic addresses, each electronic address of the plurality of electronic addresses corresponding to a respective geographic address of the plurality of unique geographic addresses; associate at least one alias with at least one electronic address of the plurality of electronic addresses; receive a retrieval request including at least one of a requested alias and a requested electronic address; and retrieve at least one geographic address associated with the at least one of the requested alias and the requested electronic address.

(2) The address retrieval apparatus of (1), wherein the processing circuitry is further configured to receive a delete-alias request including instructions to sever an association of a first alias with a first electronic address; and sever the association of the first alias with the first electronic address, according to the instructions of the delete-alias request.

(3) The address retrieval apparatus of (1) or (2), wherein the processing circuitry is further configured to receive an add-alias request including instructions to associate the first alias with a second electronic address; and associate the first alias with the second electronic address, according to the instructions of the add-alias request.

(4) The address retrieval apparatus of any one of (1) to (3), wherein the delete-alias request includes authentication data of a user, and the processing circuitry is further configured to sever the association of the first alias with the first electronic address, when the authentication data of the user indicates that the user is authorized to change the first alias, and the add-alias request includes authentication data of the user and the processing circuitry is further configured to associate the first alias with the second electronic address, when the authentication data of the user indicates that the user is authorized to change the first alias.

(5) The address retrieval apparatus of any one of (1) to (4), wherein the processing circuitry is further configured receive an address-retrieval request including authentication data of a user and address-retrieval instructions; authenticate, using authentication data of the user, whether the user is authorized to access the retrieved at least one geographic address; and provide to the user the retrieved at least one geographic address, when the user is authorized to access the retrieved at least one geographic address.

(6) The address retrieval apparatus of any one of (1) to (5), wherein the processing circuitry is further configured to receive an add-geographic-address request including authentication data of a user and a to-be-added geographic address; authenticate, using authentication data of the user, whether the user is authorized to include the to-be-added geographic address in the plurality of unique geographic addresses; include the to-be-added geographic address in the plurality of unique geographic addresses and associate the to-be-added geographic address with a new electronic address, when the user is authorized to include the to-be-added geographic address in the plurality of unique geographic addresses.

(7) The address retrieval apparatus of any one of (1) to (6), wherein the processing circuitry is further configured to receive a delete-geographic-address request including authentication data of a user and a to-be-deleted geographic address; authenticate, using authentication data of the user, whether the user is authorized to delete the to-be-deleted geographic address from the plurality of unique geographic addresses; delete the to-be-deleted geographic address from the plurality of unique geographic addresses and delete the electronic address associated with the to-be-deleted geographic address, when the user is authorized to delete the to-be-deleted geographic address from the plurality of unique geographic addresses.

(8) An address retrieval method including: associating a plurality of unique geographic addresses with a plurality of electronic addresses, each electronic address of the plurality of electronic addresses corresponding to a respective geographic address of the plurality of unique geographic addresses; associating at least one alias with at least one electronic address of the plurality of electronic addresses; receiving a retrieval request including at least one of a requested alias and a requested electronic address; and retrieving at least one geographic address associated with the at least one of the requested alias and the requested electronic address.

(9) The address retrieval method of (8), further including: receiving a delete-alias request including instructions to sever an association of a first alias with a first electronic address; and severing the association of the first alias with the first electronic address, according to the instructions of the delete-alias request.

(10) The address retrieval method of (8) or (9), further including: receiving an add-alias request including instructions to associate the first alias with a second electronic address; and associating the first alias with the second electronic address, according to the instructions of the add-alias request.

(11) The address retrieval method of any one of (8) to (10), wherein the delete-alias request includes authentication data of a user, and the processing circuitry is further configured to sever the association of the first alias with the first electronic address, when the authentication data of the user indicates that the user is authorized to change the first alias, and the add-alias request includes authentication data of the user and the processing circuitry is further configured to associate the first alias with the second electronic address, when the authentication data of the user indicates that the user is authorized to change the first alias.

(12) The address retrieval method of any one of (8) to (11), further including: receiving an address-retrieval request including authentication data of a user and address-retrieval instructions; authenticating, using authentication data of the user, whether the user is authorized to access the retrieved at least one geographic address; and providing to the user the retrieved at least one geographic address, when the user is authorized to access the retrieved at least one geographic address.

(13) The address retrieval method of any one of (8) to (12), further including: receiving an add-geographic-address request including authentication data of a user and a to-be-added geographic address; authenticating, using authentication data of the user, whether the user is authorized to include the to-be-added geographic address in the plurality of unique geographic addresses; and including the to-be-added geographic address in the plurality of unique geographic addresses and associate the to-be-added geographic address with a new electronic address, when the user is authorized to include the to-be-added geographic address in the plurality of unique geographic addresses.

(14) The address retrieval method of any one of (8) to (13), further including: receiving a delete-geographic-address request including authentication data of a user and a to-be-deleted geographic address; authenticating, using authentication data of the user, whether the user is authorized to delete the to-be-deleted geographic address from the plurality of unique geographic addresses; and deleting the to-be-deleted geographic address from the plurality of unique geographic addresses and delete the electronic address associated with the to-be-deleted geographic address, when the user is authorized to delete the to-be-deleted geographic address from the plurality of unique geographic addresses.

(15) A non-transitory computer readable storage medium including executable instruction, wherein the instructions, when executed by circuitry, cause the circuitry to perform the steps of: associating a plurality of unique geographic addresses with a plurality of electronic addresses, each electronic address of the plurality of electronic addresses corresponding to a respective geographic address of the plurality of unique geographic addresses; associating at least one alias with at least one electronic address of the plurality of electronic addresses; receiving a retrieval request including at least one of a requested alias and a requested electronic address; and retrieving at least one geographic address associated with the at least one of the requested alias and the requested electronic address.

(16) The non-transitory computer readable storage medium of (15), wherein the instructions further cause the circuitry to perform the steps of: receiving a delete-alias request including instructions to sever an association of a first alias with a first electronic address; and severing the association of the first alias with the first electronic address, according to the instructions of the delete-alias request.

(17) The non-transitory computer readable storage medium of (15) or (16), wherein the instructions further cause the circuitry to perform the steps of: receiving an add-alias request including instructions to associate the first alias with a second electronic address; and associating the first alias with the second electronic address, according to the instructions of the add-alias request.

(18) The non-transitory computer readable storage medium of any one of (15) to (17), wherein the delete-alias request includes authentication data of a user, and the processing circuitry is further configured to sever the association of the first alias with the first electronic address, when the authentication data of the user indicates that the user is authorized to change the first alias, and the add-alias request includes authentication data of the user and the processing circuitry is further configured to associate the first alias with the second electronic address, when the authentication data of the user indicates that the user is authorized to change the first alias.

(19) The non-transitory computer readable storage medium of any one of (15) to (18), wherein the instructions further cause the circuitry to perform the steps of: receiving an address-retrieval request including authentication data of a user and address-retrieval instructions; authenticating, using authentication data of the user, whether the user is authorized to access the retrieved at least one geographic address; and providing to the user the retrieved at least one geographic address, when the user is authorized to access the retrieved at least one geographic address.

(20) The non-transitory computer readable storage medium of any one of (15) to (19), wherein the instructions further cause the circuitry to perform the steps of: receiving an add-geographic-address request including authentication data of a user and a to-be-added geographic address; authenticating, using authentication data of the user, whether the user is authorized to include the to-be-added geographic address in the plurality of unique geographic addresses; including the to-be-added geographic address in the plurality of unique geographic addresses and associate the to-be-added geographic address with a new electronic address, when the user is authorized to include the to-be-added geographic address in the plurality of unique geographic addresses; receiving a delete-geographic-address request including authentication data of a user and a to-be-deleted geographic address; authenticating, using authentication data of the user, whether the user is authorized to delete the to-be-deleted geographic address from the plurality of unique geographic addresses; and deleting the to-be-deleted geographic address from the plurality of unique geographic addresses and delete the electronic address associated with the to-be-deleted geographic address, when the user is authorized to delete the to-be-deleted geographic address from the plurality of unique geographic addresses.

1. An address retrieval apparatus comprising:
processing circuitry configured to
associate a plurality of unique geographic addresses with a plurality of electronic addresses, each electronic address of the plurality of electronic addresses corresponding to a respective geographic address of the plurality of unique geographic addresses;
associate at least one alias with at least one electronic address of the plurality of electronic addresses;
receive a retrieval request including at least one of a requested alias and a requested electronic address; and
retrieve at least one geographic address associated with the at least one of the requested alias and the requested electronic address.

2. The address retrieval apparatus according to claim 1, wherein the processing circuitry is further configured to
receive a delete-alias request including instructions to sever an association of a first alias with a first electronic address; and
sever the association of the first alias with the first electronic address, according to the instructions of the delete-alias request.

3. The address retrieval apparatus according to claim 2, wherein the processing circuitry is further configured to
receive an add-alias request including instructions to associate the first alias with a second electronic address; and
associate the first alias with the second electronic address, according to the instructions of the add-alias request.

4. The address retrieval apparatus according to claim 3, wherein
the delete-alias request includes authentication data of a user, and the processing circuitry is further configured to sever the association of the first alias with the first electronic address, when the authentication data of the user indicates that the user is authorized to change the first alias, and
the add-alias request includes authentication data of the user and the processing circuitry is further configured to associate the first alias with the second electronic address, when the authentication data of the user indicates that the user is authorized to change the first alias.

5. The address retrieval apparatus according to claim 1, wherein the processing circuitry is further configured to
receive an address-retrieval request including authentication data of a user and address-retrieval instructions;
authenticate, using authentication data of the user, whether the user is authorized to access the retrieved at least one geographic address; and
provide to the user the retrieved at least one geographic address, when the user is authorized to access the retrieved at least one geographic address.

6. The address retrieval apparatus according to claim 1, wherein the processing circuitry is further configured to
receive an add-geographic-address request including authentication data of a user and a to-be-added geographic address;
authenticate, using authentication data of the user, whether the user is authorized to include the to-be-added geographic address in the plurality of unique geographic addresses; and
include the to-be-added geographic address in the plurality of unique geographic addresses and associate the to-be-added geographic address with a new electronic address, when the user is authorized to include the to-be-added geographic address in the plurality of unique geographic addresses.

7. The address retrieval apparatus according to claim 6, wherein the processing circuitry is further configured to
receive a delete-geographic-address request including authentication data of a user and a to-be-deleted geographic address;
authenticate, using authentication data of the user, whether the user is authorized to delete the to-be-deleted geographic address from the plurality of unique geographic addresses; and
delete the to-be-deleted geographic address from the plurality of unique geographic addresses and delete the electronic address associated with the to-be-deleted geographic address, when the user is authorized to delete the to-be-deleted geographic address from the plurality of unique geographic addresses.

8. An address retrieval method comprising:
associating a plurality of unique geographic addresses with a plurality of electronic addresses, each electronic address of the plurality of electronic addresses corresponding to a respective geographic address of the plurality of unique geographic addresses;
associating at least one alias with at least one electronic address of the plurality of electronic addresses;
receiving a retrieval request including at least one of a requested alias and a requested electronic address; and
retrieving at least one geographic address associated with the at least one of the requested alias and the requested electronic address.

9. The address retrieval method according to claim 8, further comprising:
receiving a delete-alias request including instructions to sever an association of a first alias with a first electronic address; and
severing the association of the first alias with the first electronic address, according to the instructions of the delete-alias request.

10. The address retrieval method according to claim 9, further comprising:
receiving an add-alias request including instructions to associate the first alias with a second electronic address; and
associating the first alias with the second electronic address, according to the instructions of the add-alias request.

11. The address retrieval method according to claim 10, wherein
the delete-alias request includes authentication data of a user, and the processing circuitry is further configured to sever the association of the first alias with the first electronic address, when the authentication data of the user indicates that the user is authorized to change the first alias, and
the add-alias request includes authentication data of the user and the processing circuitry is further configured to associate the first alias with the second electronic address, when the authentication data of the user indicates that the user is authorized to change the first alias.

12. The address retrieval method according to claim 11, further comprising:
receiving an address-retrieval request including authentication data of a user and address-retrieval instructions;
authenticating, using authentication data of the user, whether the user is authorized to access the retrieved at least one geographic address; and
providing to the user the retrieved at least one geographic address, when the user is authorized to access the retrieved at least one geographic address.

13. The address retrieval method according to claim 8, further comprising:
receiving an add-geographic-address request including authentication data of a user and a to-be-added geographic address;
authenticating, using authentication data of the user, whether the user is authorized to include the to-be-added geographic address in the plurality of unique geographic addresses; and
including the to-be-added geographic address in the plurality of unique geographic addresses and associate the to-be-added geographic address with a new electronic address, when the user is authorized to include the to-be-added geographic address in the plurality of unique geographic addresses.

14. The address retrieval method according to claim 13, further comprising:
receiving a delete-geographic-address request including authentication data of a user and a to-be-deleted geographic address;
authenticating, using authentication data of the user, whether the user is authorized to delete the to-be-deleted geographic address from the plurality of unique geographic addresses; and
deleting the to-be-deleted geographic address from the plurality of unique geographic addresses and delete the electronic address associated with the to-be-deleted geographic address, when the user is authorized to delete the to-be-deleted geographic address from the plurality of unique geographic addresses.

15. A non-transitory computer readable storage medium including executable instruction, wherein the instructions, when executed by circuitry, cause the circuitry to perform the steps of:
associating a plurality of unique geographic addresses with a plurality of electronic addresses, each electronic address of the plurality of electronic addresses corresponding to a respective geographic address of the plurality of unique geographic addresses;
associating at least one alias with at least one electronic address of the plurality of electronic addresses;
receiving a retrieval request including at least one of a requested alias and a requested electronic address; and
retrieving at least one geographic address associated with the at least one of the requested alias and the requested electronic address.

16. The non-transitory computer readable storage medium according to claim 15, wherein the instructions further cause the circuitry to perform the steps of:
receiving a delete-alias request including instructions to sever an association of a first alias with a first electronic address; and
severing the association of the first alias with the first electronic address, according to the instructions of the delete-alias request.

17. The non-transitory computer readable storage medium according to claim 17, wherein the instructions further cause the circuitry to perform the steps of:
receiving an add-alias request including instructions to associate the first alias with a second electronic address; and
associating the first alias with the second electronic address, according to the instructions of the add-alias request.

18. The non-transitory computer readable storage medium according to claim 17, wherein
the delete-alias request includes authentication data of a user, and the processing circuitry is further configured to sever the association of the first alias with the first electronic address, when the authentication data of the user indicates that the user is authorized to change the first alias, and
the add-alias request includes authentication data of the user and the processing circuitry is further configured to associate the first alias with the second electronic address, when the authentication data of the user indicates that the user is authorized to change the first alias.

19. The non-transitory computer readable storage medium according to claim 18, wherein the instructions further cause the circuitry to perform the steps of:
receiving an address-retrieval request including authentication data of a user and address-retrieval instructions;
authenticating, using authentication data of the user, whether the user is authorized to access the retrieved at least one geographic address; and
providing to the user the retrieved at least one geographic address, when the user is authorized to access the retrieved at least one geographic address.

20. The non-transitory computer readable storage medium according to claim 15, wherein the instructions further cause the circuitry to perform the steps of:
receiving an add-geographic-address request including authentication data of a user and a to-be-added geographic address;
authenticating, using authentication data of the user, whether the user is authorized to include the to-be-added geographic address in the plurality of unique geographic addresses;
including the to-be-added geographic address in the plurality of unique geographic addresses and associate the to-be-added geographic address with a new electronic address, when the user is authorized to include the to-be-added geographic address in the plurality of unique geographic addresses;
receiving a delete-geographic-address request including authentication data of a user and a to-be-deleted geographic address;
authenticating, using authentication data of the user, whether the user is authorized to delete the to-be-deleted geographic address from the plurality of unique geographic addresses; and
deleting the to-be-deleted geographic address from the plurality of unique geographic addresses and delete the electronic address associated with the to-be-deleted geographic address, when the user is authorized to delete the to-be-deleted geographic address from the plurality of unique geographic addresses.
